(19) United States
(12) Patent Application Publication
(10) Pub. No.: US 2013/0195089 A1
(43) Pub. Date: Aug. 1, 2013

(54) SUPER LONG RANGE (SLR) DEVICES AND LOW RATE ENABLER (LRE) DEVICES

(71) Applicants: Rahul Tandra, San Diego, CA (US); Santosh P. Abraham, San Diego, CA (US); Stephen J. Shellhammer, Ramona, CA (US)

(72) Inventors: Rahul Tandra, San Diego, CA (US); Santosh P. Abraham, San Diego, CA (US); Stephen J. Shellhammer, Ramona, CA (US)

(73) Assignee: QUALCOMM INCORPORATED, San Diego, CA (US)

(21) Appl. No.: 13/362,934

(22) Filed: Jan. 31, 2012

(51) Int. Cl. H04W 4/00; H04W 84/12

(52) U.S. Cl. 370/338; 370/328

(57) ABSTRACT

A method includes generating, at a low rate enabler (LRE) device, a packet including a preamble having a legacy portion and a super long range (SLR) portion. The legacy portion includes at least one bit to indicate a presence of the SLR portion to at least one SLR-compatible device. The method also includes transmitting the packet to a plurality of devices includes the at least one SLR-compatible device.

### I. FIELD

The present disclosure is generally related to television white space data communications.

### II. DESCRIPTION OF RELATED ART

In many countries, wireless transmission frequency bands are regulated by a government regulatory agency. For example, in the United States, the Federal Communications Commission (FCC) regulates wireless transmission frequency bands and in the United Kingdom, the Office of Communications (Ofcom) regulates wireless transmission frequency bands. The FCC and similar regulatory agencies in other countries issue licenses to broadcast in particular frequency ranges. To illustrate, a television broadcaster may be licensed for television channel transmission for a particular channel defined within a particular frequency range in a particular geographic area.

As demand for wireless data communications has increased, some regulatory agencies have recognized that current licensing schemes may lead to inefficient use of the wireless transmission frequency spectrum. As a result, regulatory agencies have enacted rules to allow unlicensed users (such as individual consumers) to use licensed frequencies in “white spaces.” A white space may generally refer to a frequency range (e.g., one or more channels) that is regulated but unused within a particular geographic area at a particular time. For example, the FCC recently made vacant/unused television (TV) white space spectrum available for unlicensed use to TV band devices (TVBDs). The FCC has also set guidelines that must be met in order for TV band devices to use the TV white space (TVWS).

### III. SUMMARY

The TVWS (i.e., the Institute of Electrical and Electronics Engineers (IEEE) 802.11af standard) spectrum in the U.S. includes TV channels in the range of 54 to 698 MHz. The FCC recognizes two kinds of TV band devices, including a Mode I personal/portable TVBD (“Mode I device” or “slave device”) and a Mode II personal/portable TVBD (“Mode II device” or “master device”). The FCC and similar regulatory agencies in other countries do not require slave devices to have internal geolocation capability or to have access to a TV white space (TVWS) database to obtain a list of available channels (i.e., TVWS channels) for communication. However, master devices or access points must have internal geolocation capability (within a 50 m accuracy in the U.S.) and access to the TVWS database to obtain a list of available TVWS channels on which the master device and slave devices connected thereto can operate. This geolocation requirement of the FCC may be difficult to meet in indoor environments (e.g., office buildings, malls, or apartment complexes). Further, indoor geo-location technologies may be expensive to implement.

A low rate enabler (LRE) may serve as a Mode II device/master device and may provide enablement to Mode I/slave devices in a wide region (e.g., office buildings, malls, or apartment complexes). The LRE device may be equipped with a global positioning system (GPS) receiver and may be located near a window or on a rooftop of a building to obtain a GPS lock and satisfy the 50 m geolocation accuracy requirement of the FCC. Various devices may serve as a Mode I/slave devices and may communicate with the LRE device. For example, the LRE device may serve as a Wi-Fi access point for a plurality of devices connected to the LRE device. Generally, Mode I devices may include “legacy” devices and super long range (SLR) devices that have a larger range than the legacy devices.

It may thus be desirable to design an LRE device that can communicate with SLR devices operating in a longer range and that can also communicate with existing legacy devices operating in shorter ranges (i.e., enable both SLR devices and existing legacy devices). For example, the SLR devices and LRE devices that comply with the IEEE 802.11af standard may be configured to communicate with (i.e., may be backward compatible with) existing legacy devices such as 802.11a devices, 802.11b devices, 802.11g devices, and 802.11b devices. Further, by implementing backward compatibility, the IEEE 802.11af standard devices (i.e., LRE devices and SLR devices) may be utilized without sacrificing interoperability with existing standard devices (i.e., legacy devices). Backward compatibility may also help prevent potential collision of signals between transmitting devices and resolve medium contention. For example, an LRE device transmitting a packet to an SLR device may instruct legacy devices to stop transmission across a channel for a duration of time to enable successful transmission of the packet to the SLR device.

The method for backward compatibility of the LRE devices with legacy devices (i.e., non-SLR-compatible devices) may be implemented in the physical layer (PHY) or in the medium access control layer (MAC) layer. A PHY layer method may include modifying a legacy portion (e.g., a legacy preamble) of a packet to indicate a presence of an SLR portion (e.g., a SLR preamble) of the packet prior to transmitting the packet. Thus, a packet including the legacy portion and the SLR portion may be transmitted to a plurality of devices connected to the LRE device (i.e., legacy devices and SLR-compatible devices).

A MAC layer method may include transmitting, from the LRE device, a clear-to-send (CTS)-to-self message via a wireless network (e.g., IEEE 802.11ah wireless network) to a legacy device to prevent the legacy device from communicating via the wireless network for a duration of time. The duration of time may be specified by a duration field of the CTS-to-self message. During this reserved duration of time, the LRE device may transmit a packet including the SLR preamble to an SLR-compatible device and may receive an acknowledgement (ACK) packet from the SLR-compatible device. Thus, legacy devices may be prevented from interfering with an LRE device communicating with SLR-compatible via a wireless network during a specified time period.

In a particular embodiment, a method includes generating, at a low rate enabler (LRE) device, a packet including a preamble having a legacy portion and a super long range (SLR) portion. The legacy portion includes at least one bit to indicate a presence of the SLR portion to at least one SLR-compatible device. The method also includes transmitting the packet to a plurality of devices including the at least one SLR-compatible device.

In another particular embodiment, a method includes receiving a packet including a preamble at a super long range (SLR)-compatible device. The method includes decoding a legacy portion of the preamble to determine whether the legacy portion of the preamble includes at least one bit indicating a presence of an SLR portion in the preamble.

In another particular embodiment, a method includes transmitting from a low rate enabler (LRE) device to a legacy device, a clear-to-send (CTS)-to-self message to prevent the legacy device from communicating via a network medium for a duration of time specified by a duration field of the CTS-to-self message. During the duration of time, the method includes transmitting a packet including a preamble having a super long range (SLR) portion to an SLR-compatible device and receiving an acknowledgement (ACK) packet from the SLR-compatible device.

In another particular embodiment, an apparatus includes a processor and a memory storing instructions executable by the processor to generate a packet including a preamble having a legacy portion and a super long range portion. The legacy portion includes at least one bit to indicate a presence of the SLR portion to at least one SLR-compatible device. The instructions are also executable by the processor to initiate transmission of the packet to at least one device.

In another particular embodiment, an apparatus includes a processor and a memory storing instructions executable by the processor to detect receipt of a packet including a preamble and to decode a legacy portion of the preamble to determine whether the legacy portion of the preamble includes at least one bit indicating a presence of an SLR portion of the preamble.

In another particular embodiment, an apparatus includes a processor and a memory storing instructions executable by the processor to initiate transmission of a clear-to-send (CTS)-to-self message to a legacy device to prevent the legacy device from communicating via a network medium for a duration of time specified by a duration field of the CTS-to-self message. During the duration of time, the instructions are further executable by the processor to initiate transmission of a packet including a preamble having a super long range (SLR) portion to an SLR-compatible device and to detect receipt of an acknowledgement (ACK) packet from the SLR-compatible device.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative embodiment of a system including super long range (SLR) devices and a low rate enabler (LRE) device that is backward compatible with legacy devices;

FIG. 2 is a diagram of a particular embodiment of the packet sent by the LRE device in the system of FIG. 1;

FIG. 3 is a diagram illustrating a particular embodiment representing a medium access (MAC) layer technique of the system of FIG. 1;

FIG. 4 is a flow chart of a first particular embodiment of a method of using the SLR devices and the LRE device of the system of FIG. 1 that is backward compatible with legacy devices;

FIG. 5 is a flow chart of a second particular embodiment of a method of using the SLR devices and the LRE device of the system of FIG. 1 that is backward compatible with legacy devices;

FIG. 6 is a flow chart of a third particular embodiment of a method of using the SLR devices and the LRE device of the system of FIG. 1 that is backward compatible with legacy devices; and

FIG. 7 is a block diagram of a particular embodiment of a wireless device including a processor operable to decode a packet including a legacy portion and an SLR portion.

### V. DETAILED DESCRIPTION

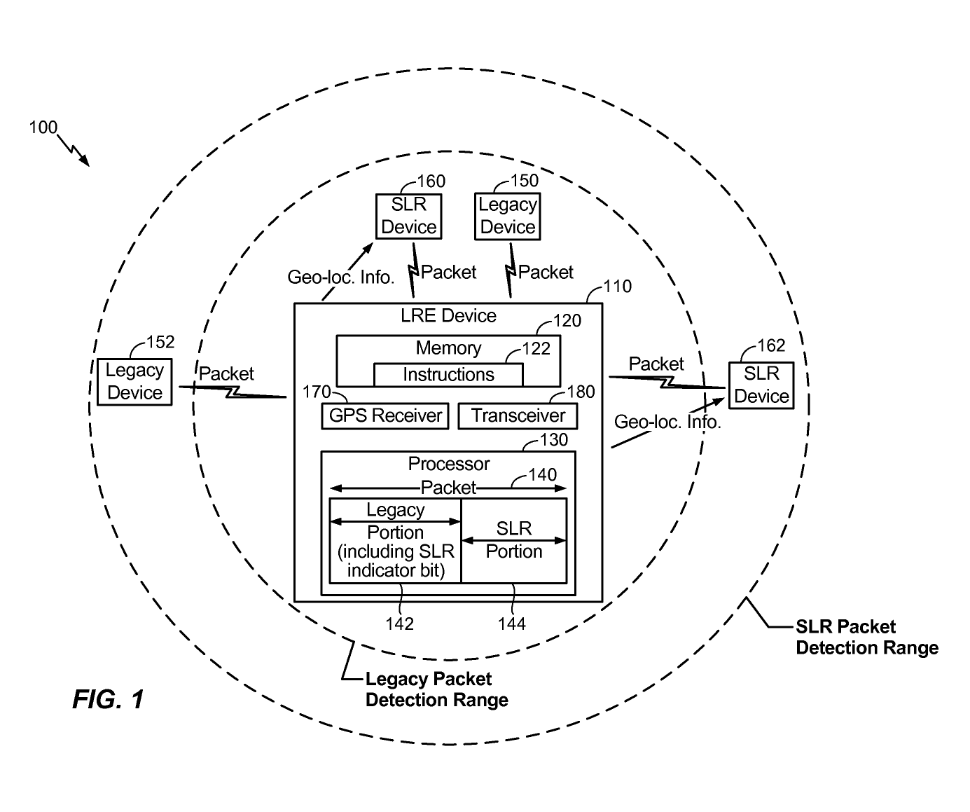

Referring to FIG. 1, a block diagram of a particular illustrative embodiment of a system including super long range (SLR) devices and a low rate enabler (LRE) device that is backward compatible with legacy devices is disclosed and generally designated 100. The system 100 includes a plurality of wireless devices 150, 152, 160, and 162 coupled to an LRE device 110. In a particular embodiment, the plurality of wireless devices 150-162 include a plurality of legacy devices and a plurality of super long range (SLR)-compatible devices (i.e., SLR devices) wirelessly coupled to the LRE device. Thus, the LRE device 110 may be configured to communicate with a plurality of devices in a plurality of networks (e.g., IEEE 802.11a/b/g/n based networks and IEEE 802.11af based networks). As illustrated, the plurality of legacy devices include a first legacy device 150 and a second legacy device 152, and the plurality of SLR devices include a first SLR device 160 and a second SLR device 162. In a particular embodiment, the SLR devices 160, 162 are configured to operate at a maximum channel bandwidth of 6 MHz and at a data rate of 63.5 Kb/s.

In a particular embodiment, the LRE device is an Institute of Electrical and Electronics Engineers (IEEE) 802.11af Mode II device configured to enable a plurality of IEEE 802.11af Mode I devices (e.g., the first SLR device 160 and the second SLR device 162) to connect to the LRE device 110 via one or more channels of a network medium (e.g., one or more channels of an IEEE 802.11af communication network medium). For example, the LRE device may be configured to operate as a Wi-Fi access point for the plurality of 802.11af Mode I devices and may further be configured to provide geo-location information within a 50 m accuracy to the 802.11af Mode I devices. In another particular embodiment, the plurality of legacy devices (i.e., the first legacy device 150 and the second legacy device 152) include at least one of an IEEE 802.11a device, an IEEE 802.11b device, an IEEE 802.11g device, and an IEEE 802.11b device. Moreover, the plurality of wireless devices 150-162 may include a mobile device, a portable computer, a personal digital assistant (PDA), a multimedia player, an entertainment unit, a navigation device, a communications device, a camera, or any combination thereof.

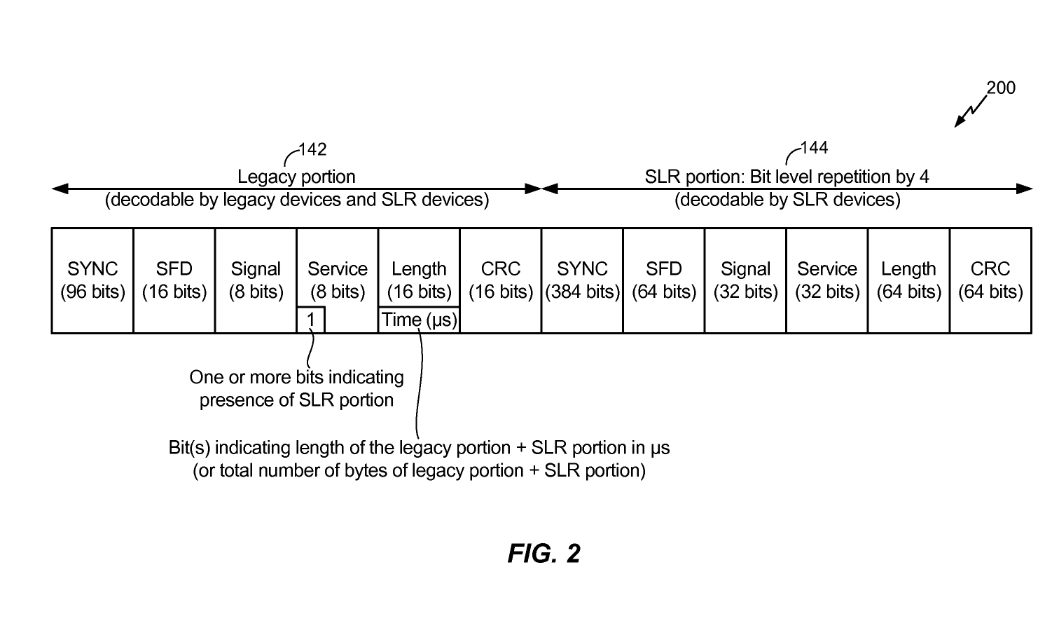

The LRE device 110 may include a memory 120, a global positioning system (GPS) receiver 170, a transceiver 180, and a processor 130. The memory 120 may store instructions 122 executable by the processor 130. The memory 120 may also store packets (e.g., representative packet 140) generated by the processor 130 to be transmitted to the plurality of devices 150-162. In a particular embodiment, the processor 130 may be configured to generate the packet 140 including a preamble having a legacy portion 142 and a SLR portion 144. In a particular embodiment, the legacy portion 142 may include at least one bit to indicate a presence of the SLR portion 144 to the SLR devices 160, 162. In another particular embodiment, the legacy portion 142 may include a length field to prevent the legacy devices 150, 152 from communicating via one or more channels of a wireless communication medium for a particular time period. Further, the legacy portion 142 may be decodable by the legacy devices 150, 152 while the SLR portion 144 may not be decodable (i.e., “undecodable”) by the legacy devices 150, 152. However, both the legacy portion 142 and the SLR portion 144 of the packet 140 may be decodable by the SLR devices 160, 162. The packet 140 including the legacy portion 142 and the SLR portion 144 is described in detail with reference to FIG. 2.

By generating the packet 140 having the legacy portion 142 and the SLR portion 144, the LRE device may communicate with both the SLR devices 160, 162 and the legacy devices 150, 152 (i.e., backward compatibility may be achieved). The GPS receiver 170 may be configured to receive GPS signals at the LRE device 110 and provide geo-location information from the LRE device 110 to the SLR devices 160, 162. In a particular embodiment, the geo-location information may be sent to the SLR devices 160, 162 every sixty seconds. The transceiver 180 may be configured to receive and to transmit packets (e.g., the data packet 140) to the wireless devices 150-162. Although the GPS receiver 170 and the transceiver 180 are shown as separate devices, it should be noted that the GPS receiver may be integrated into the transceiver 180.

During operation, the LRE device 110 may generate the packet 140 and may transmit the packet 140 to the SLR devices 160, 162 and to the legacy devices 150, 152 located at various distances from the LRE device 110. For example, the first SLR device 160 and the first legacy device 150 may be located within a legacy packet detection range, as illustrated. Further, the second SLR device 162 and the second legacy device 152 may be located outside the legacy packet detection range but within an SLR packet detection range. The legacy packet detection range indicates a maximum distance a receiver (i.e., legacy device 150 or 152) may be located relative to a transmitter (i.e., the LRE device 110) in order to receive a legacy packet sent by the transmitter. Similarly, the SLR packet detection range indicates a maximum distance a receiver (i.e., SLR device 160 or 162) may be located relative to a the transmitter in order to receive an SLR packet sent by the transmitter.

When the packet 140 is transmitted from the LRE device 110, the first legacy device 150 located within the legacy packet detection range may receive the packet 140 including the legacy portion 142 and the SLR portion 144. The first legacy device 150 may decode the legacy portion 142, detect the length field of the length field of the legacy portion 142, and may defer from communicating via the at least one wireless channel for a period of time specified in the length field of the legacy portion 142. In addition, the first legacy device 150 may ignore the SLR portion 144 of the received packet 140 (i.e., because the SLR portion 144 is “undecodable” or “unintelligible” to the legacy device 150). The first SLR device 160 within the legacy packet detection range may receive the packet 140 including the legacy portion 142 and the SLR portion 144. The first SLR device 160 may begin decoding the legacy portion 142, may detect the modified bit(s) in the service field of the legacy portion 142, may determine that the SLR portion 144 follows the legacy portion 142 based on the modified bit(s), and may begin decoding the SLR portion 144.

The second legacy device 152 located outside the legacy packet detection range may only receive the SLR portion 144 of the transmitted packet 140. Because the second legacy device 152 is unable to decode the SLR portion 144, the second legacy device 152 may simply ignore the SLR portion. The second SLR device 162 located outside the legacy packet detection range may only receive the SLR portion 144 of the transmitted packet 140. Because the SLR portion 144 is decodable by the second SLR device 162, the second SLR device 162 may begin decoding the SLR portion 144. Thus, the LRE device 110 may reserve the at least one wireless channel for communication with an SLR device for a particular time period specified in the legacy portion 142 of the packet 140 by preventing a legacy device located within a legacy packet detection range from communicating via the at least one channel for the particular period of time. Further, legacy devices located outside the legacy packet detection range (i.e., within the SLR packet detection range) that may receive the SLR portion 144 do not interfere with communication with the SLR device because such legacy devices are unable to decode the SLR portion 144. Hence, collision of signals caused by multiple devices transmitting on the same channel may be avoided.

Referring to FIG. 2, a particular embodiment of the packet sent by the LRE device in the system of FIG. 1 is disclosed and generally designated 200. The packet 140 includes the legacy portion 142 and the SLR portion 144. The legacy portion 142 may precede the SLR portion 144, as illustrated. In a particular embodiment, the legacy portion 142 may be decodable by the legacy devices 150, 152 while the SLR portion 144 may not be decodable by the legacy devices 150, 152. However, both the legacy portion 142 and the SLR portion 144 of the packet 140 may be decodable by the SLR devices 160, 162.

In a particular embodiment, the legacy portion 142 is based on an IEEE 802.11 preamble. For example, the legacy portion 142 may include a plurality of fields including a SYNC field having 96 bits, an SFD field having 16 bits, a signal field having 8 bits, a service field having 8 bits, a length field having 16 bits, and a CRC field having 16 bits. The service field of the legacy portion 142 may include one or more bits to indicate a presence of the SLR portion 144. As illustrated, legacy portion 142 may include one or more bits located at a most significant (MSB) bit position of the service field to indicate the presence of the SLR portion 144 to the SLR devices 160, 162, where the SLR portion 144 follows the legacy portion 142.

In a particular embodiment, the length field of the legacy portion 142 prevents the legacy devices 150, 152 from communicating via the at least one wireless channel for a particular time period, where the particular time period is based at least in part on a length of the SLR portion 144. For example, the length field may include one or more bits representing a length of the sum of the legacy portion 142 and the SLR portion. In one embodiment, the length may be represented in time (e.g., microseconds). In another embodiment, the length may be represented as a total number of bytes of the legacy portion 142 and the SLR portion 144. In both embodiments, the information represented in the length field prevents a legacy device receiving the legacy portion 142 from communicating via the at least one channel for the indicated time period.

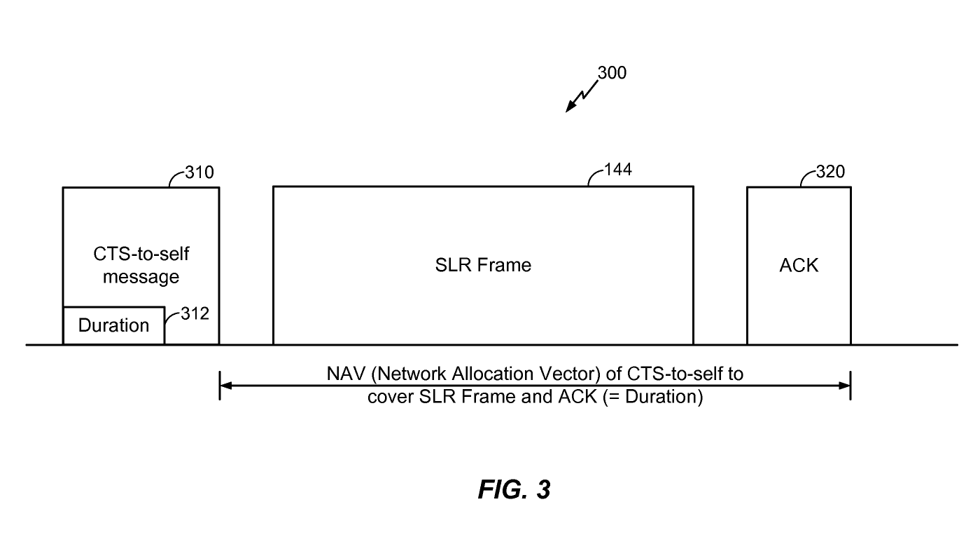

In a particular embodiment, the SLR portion 144 is generated by performing bit-level repetition by four on each of the plurality of fields of the IEEE 8022.11 preamble (or the legacy portion 142). Thus, the SLR portion 144 may include the SYNC field having 384 bits, the SFD field having 64 bits, the signal field having 32 bits, the service field having 32 bits, the length field having 64 bits, and the CRC field having 64 bits, as illustrated. The SLR devices 160, 162 are configured to decode the SLR portion 144 of the packet 140. It should be noted that FIGS. 1 and 2 describe a PHY layer implementation of the disclosed embodiments. FIG. 3 describes a MAC layer implementation of the disclosed embodiments.

Referring to FIG. 3, a particular embodiment representing a medium access (MAC) layer technique of the system of FIG. 1 is disclosed and generally designated 300. The MAC layer technique 300 may include transmitting, from the LRE device 110, a clear-to-send (CTS)-to-self message 310 to a legacy device (e.g., the first legacy device 150 or the second legacy device 152) to prevent the legacy device from communicating via a network medium for a duration of time specified by a duration field 312 of the CTS-to-self message 310. In a particular embodiment, the network medium may include an IEEE 802.11af communication network (i.e., a TVWS communication medium). The duration of time specified by the duration field 312 may be calculated based at least in part on a length of the SLR portion 144 (or SLR frame). For example, the duration of time may be a time sufficient for the LRE device 110 to transmit the SLR portion 144 to an SLR device (e.g., the first SLR device 160 or the second SLR device 162) and to receive a response from the SLR device (e.g., an acknowledgement (ACK) packet 320).

During the duration of time, the LRE device 110 may transmit the packet 140 including the SLR portion 144 to the first SLR device 160 or to the second SLR device 162. In response to transmitting SLR portion 144, the LRE device 110 may receive the ACK packet 320 from the SLR device 160, 162. Accordingly, the LRE device 110 may reserve one or more channels of network medium (e.g., an IEEE 802.11af network medium) to communicate with an SLR device for a particular time period, thereby preventing collision and/or interference by legacy devices.

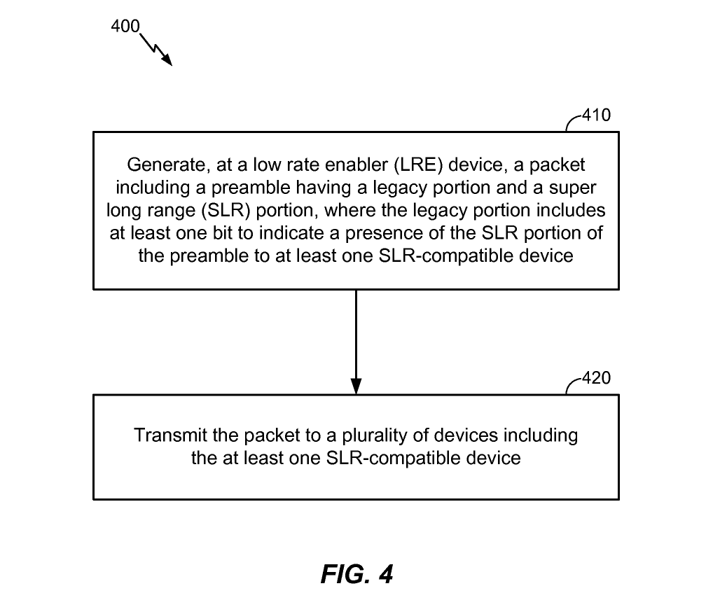

Referring to FIG. 4, a flow chart of a first particular embodiment of a method of using the SLR device and the LRE device of the system of FIG. 1 that is backward compatible with legacy devices is disclosed and generally designated 400. The method 400 may be performed by an LRE device, such as the LRE device 110 of FIG. 1

The method 400 includes generating, at an LRE device, a packet including a preamble having a legacy portion and an SLR portion, where the legacy portion includes at least one bit to indicate a presence of the SLR portion of the preamble to at least one SLR-compatible device, at 410. For example, the processor 130 of the LRE device 110 may be configured to generate the packet 140 having a legacy portion 142 and an SLR portion 144. The legacy portion 142 may include a plurality of fields including a service field having one or more bits (e.g., located at a MSB bit position) to indicate the presence of the SLR portion 144 to SLR devices 160, 162. In a particular embodiment, the packet 140 may also include geo-location information (e.g., in a payload packet) for the SLR devices 160, 162, where the geo-location information is transmitted every sixty seconds.

The method 400 also includes transmitting the packet to a plurality of devices including the at least one SLR-compatible device, at 420. For example, the LRE device 110 may transmit the packet 140 to the legacy devices 150, 152 and to the SLR devices 160, 162. In a particular embodiment, the legacy portion 142 is decodable by the legacy devices 150, 152 and by the SLR devices 160, 162, and the SLR portion 144 is decodable by the SLR devices 160, 162.

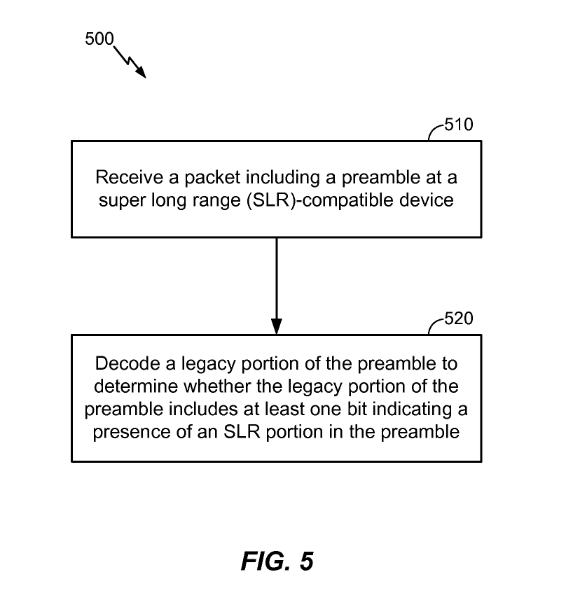

Referring to FIG. 5, a flow chart of a second particular embodiment of a method of using the SLR device and the LRE device of the system of FIG. 1 that is backward compatible with legacy devices is disclosed and generally designated 500. The method 500 may be performed by an SLR device, such as the SLR devices 160, 162 of FIG. 1.

The method 500 includes receiving a packet including a preamble at an SLR-compatible device, at 510. For example, one or more of the SLR devices 160, 162 may receive the packet 140 transmitted by the LRE device 110. The packet 140 may include a legacy portion 142 and an SLR portion 144.

The method also includes decoding a legacy portion of the preamble to determine whether the legacy portion of the preamble includes at least one bit indicating a presence of an SLR portion in the preamble, at 520. For example, one or more of the SLR devices 160, 162 may decode the legacy portion 142 to determine whether the legacy portion 142 includes one or more bits indicating the presence of the SLR portion 144. To illustrate, the service field of the legacy portion 142 may include one or more bits indicating the presence of the SLR portion 144. The one or more bits may be located at a MSB bit position of the service field.

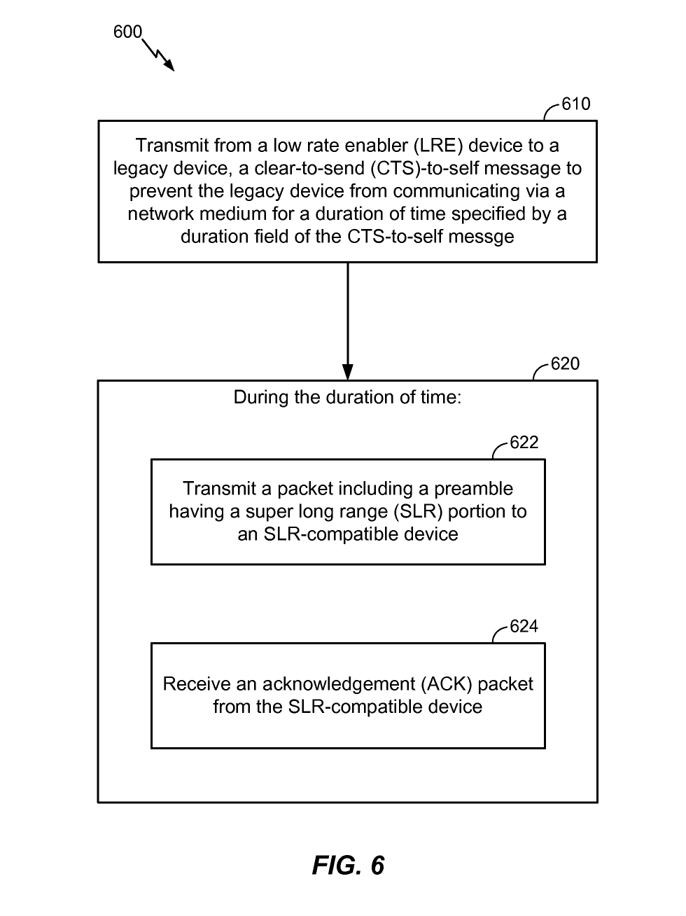

Referring to FIG. 6, a flow chart of a third particular embodiment of a method of using the SLR device and the LRE device of the system of FIG. 1 that is backward compatible with legacy devices is disclosed and generally designated 600. The method 600 may be performed by an LRE device, such as the LRE device 110 of FIG. 1.

The method 600 includes transmitting from an LRE device to a legacy device, a CTS-to-self message to prevent the legacy device from communicating via a network medium for a duration of time specified by a duration field of the CTS-to-self message, at 610. For example, the LRE device 110 may transmit the CTS-to-self message 310 including the duration field 312. The duration field 312 may specify a duration of time (e.g., in microseconds) that the legacy device (i.e., one or more of the legacy devices 150, 152) may not communicate via the network medium. In a particular embodiment, the duration of time may be calculated based on a length of the SLR portion 144. Further, the duration of time may be a time sufficient for the LRE device to transmit the SLR portion to an SLR device (e.g., the first SLR device 160 or the second SLR device 162) and to receive an ACK packet from the SLR device.

During the duration of time, at 620, the method 600 includes transmitting a packet including a preamble having an SLR portion to an SLR-compatible device, at 522, and receiving an acknowledgement (ACK) packet from the SLR-compatible device, at 624. For example, during the time period indicated in the duration field 312, the LRE device 110 may transmit the SLR portion 144 to one or more of the SLR devices 160, 162, and receive the ACK packet 320 from the one or more SLR devices 160, 162.

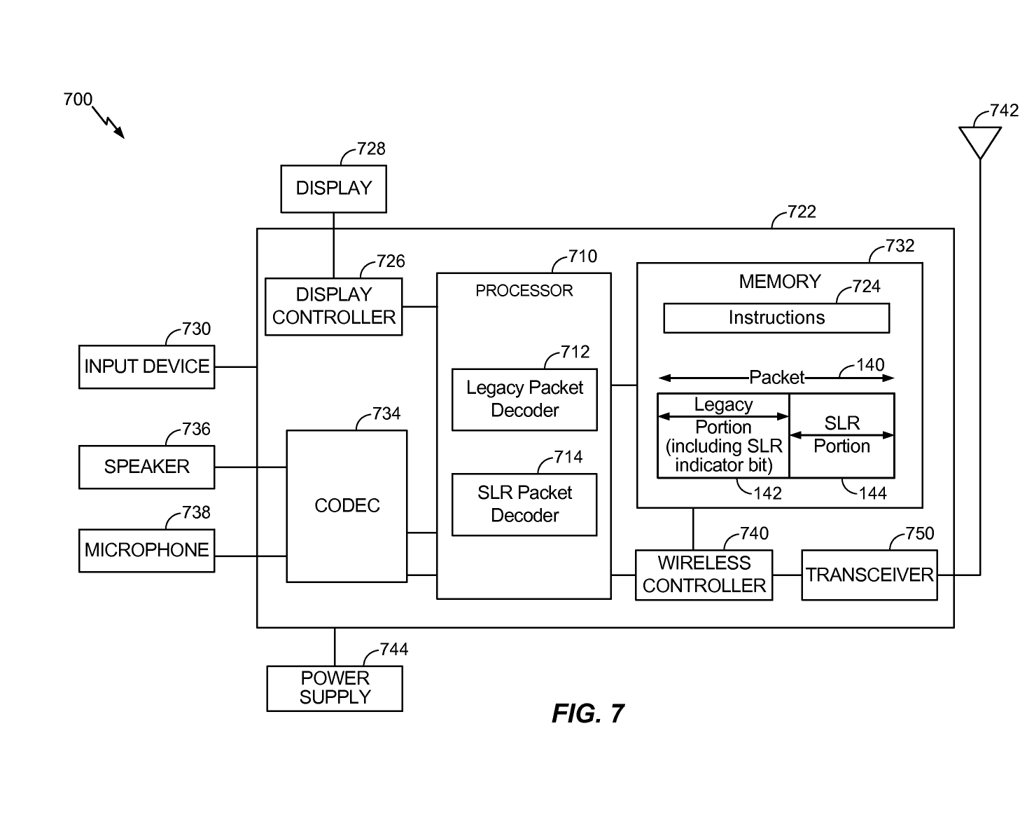

Referring to FIG. 7, a block diagram of a particular illustrative embodiment of a wireless device including a processor operable to decode a packet including a legacy portion and an SLR portion is disclosed and generally designated 700. The device 700 includes a processor, such as a processor 710, coupled to a memory 732. The processor 710 may include a legacy packet decoder 712 and an SLR packet decoder 714.

The memory 732 may be a non-transitory computer readable storage medium that stores data, instructions, or both. In a particular embodiment, the memory 732 may include instructions 722 that may be executable by the processor 710 to cause the processor 710 to perform one or more functions of the device 700. For example, the instructions 722 may include user applications, an operating system, or other executable instructions, or any combination thereof. For example, the instructions 722 may include instructions that are executable by a computer (e.g., the processor 710) to cause the computer to perform the method 500 of FIG. 5. Further, the memory 732 may store the packet 140 including the legacy portion 142 and the SLR portion 144 transmitted from the LRE device 110.

The legacy packet decoder 712 may be configured to decode the legacy portion 142 and the SLR packet decoder 714 may be configured to decode the SLR portion 144. Thus, the device 700 may be operable to decode both the legacy portion 142 and the SLR portion of the packet 140 transmitted from the LRE device 110. In a particular embodiment, the legacy portion 142 may include one or more bits indicating to the device 700 that an SLR portion is present in the packet 140.

FIG. 7 also shows a display controller 726 that may be coupled to the processor 710 and to a display 728. A coder/decoder (CODEC) 734 (e.g., an audio and/or voice CODEC) may be coupled to the processor 710. A speaker 736 and a microphone 738 may be coupled to the CODEC 734. FIG. 7 also indicates that a wireless controller 7940 may be coupled to the processor 710 and to a transceiver 750 that is coupled to a wireless antenna 742. In a particular embodiment, the processor 710 may detect receipt of a packet (e.g., the packet 140 including the legacy portion 142 and the SLR portion 144) from the LRE device 110 and may initiate sending of the ACK packet 320 to the LRE device 110.

In a particular embodiment, the processor 710, the display controller 726, the memory 732, the CODEC 734, the wireless controller 740, and the transceiver 750 are included in a system-in-package or system-on-chip device 722.

In a particular embodiment, an input device 730 and a power supply 744 are coupled to the system-on-chip device 722. Moreover, in a particular embodiment, as illustrated in FIG. 7, the display 728, the input device 730, the speaker 736, the microphone 738, the wireless antenna 742, and the power supply 744 are external to the system-on-chip device 722. However, each of the display 728, the input device 730, the speaker 736, the microphone 738, the wireless antenna 742, and the power supply 744 can be coupled to a component of the system-on-chip device 722, such as an interface or a controller.

It should be noted that although FIG. 7 depicts a wireless communications device, the processor 710 and the memory 732 may be integrated into other devices, such as an SLR device (e.g., the SLR devices 160, 162 of FIG. 1), a mobile device, a camera, a multimedia player, an entertainment unit, a navigation device, a personal digital assistant (PDA), a computer (e.g., a tablet computer, a laptop computer, a desktop computer, etc), a fixed location data unit, a router or gateway device, or another device configured to wirelessly communicate data.

In conjunction with the described embodiments, an apparatus is disclosed that includes means for generating, at a low rate enabler (LRE) device, a packet including a preamble having a legacy portion and an SLR portion, where the legacy portion includes at least one bit to indicate a presence of the SLR portion to at least one SLR-compatible device. For example, the means for generating may include the processor 130 of FIG. 1, the LRE device 110 of FIG. 1, one or more other devices configured to generate a packet including a preamble having a legacy portion and an SLR portion, or any combination thereof.

The apparatus may also include means for transmitting the packet to at least one device. For example, the means for transmitting the packet may include the transceiver 180 of FIG. 1, the LRE device 110 of FIG. 1, one or more other devices configured to transmit the packet to at least one device, or any combination thereof.

In conjunction with the described embodiments, an apparatus is disclosed that includes means for receiving a packet including a preamble at an SLR-compatible device. For example, the means for receiving may include the first SLR device 160 and the second SLR device 162 of FIG. 1, the antenna 742 of FIG. 7, the transceiver 750 of FIG. 7, the device 700 of FIG. 7, one or more other devices configured to receive a packet, or any combination thereof.

The apparatus may also include means for decoding a legacy portion of the preamble to determine whether the legacy portion of the preamble includes at least one bit indicating a presence of an SLR portion in the preamble. For example, the means for decoding the legacy portion may include the first SLR device 160 and the second SLR device 162 of FIG. 1, the legacy portion decoder 712 of FIG. 7, the processor 710 of FIG. 7, the device 700 of FIG. 7, one or more other devices configured to decode a legacy portion of a packet, or any combination thereof.

In conjunction with the described embodiments, an apparatus is disclosed that includes means for transmitting from an LRE device to a legacy device, a CTS-to-self message to prevent the legacy device from communicating via a network medium for a duration of time specified by a duration field of the CTS-to-self message. For example, the means for transmitting may include the transceiver 180 of FIG. 1, the LRE device 110 of FIG. 1, one or more other devices configured to transmit a CTS-to-self message, or any combination thereof.

The apparatus may also include means for transmitting, during the duration of time, a packet including a preamble having an SLR portion to an SLR-compatible device. For example, the means for transmitting the packet may include transceiver 180 of FIG. 1, the LRE device 110 of FIG. 1, one or more other devices configured to transmit a packet, or any combination thereof.

The apparatus may also include means for receiving an ACK packet from the SLR-compatible device. For example, the means for receiving may include the transceiver 180 of FIG. 1, the LRE device 110 of FIG. 1, one or more other devices configured to receive an ACK packet, or any combination thereof.

Those of skill would further appreciate that the various illustrative logical blocks, configurations, modules, circuits, and algorithm steps described in connection with the embodiments disclosed herein may be implemented as electronic hardware, computer software, or combinations of both. Various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transitory storage medium. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal (e.g., a mobile phone or a PDA). In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments disclosed herein but is to be accorded the widest scope possible consistent with the principles and novel features as defined by the following claims.

What is claimed is:

1. A method comprising:
generating, at a low rate enabler (LRE) device, a packet including a preamble having a legacy portion and a super long range (SLR) portion, wherein the legacy portion includes at least one bit to indicate a presence of the SLR portion to at least one SLR-compatible device; and
transmitting the packet to a plurality of devices including the at least one SLR-compatible device.

2. The method of claim 1, further comprising sending enablement information from the LRE device to the at least one SLR-compatible device, wherein the enablement information is sent to the at least one SLR-compatible device every sixty seconds.

3. The method of claim 1, wherein the plurality of devices further includes at least one legacy device and wherein the at least one legacy device includes at least one of an Institute of Electrical and Electronic Engineers (IEEE) 802.11a device, an IEEE 802.11b device, an IEEE 802.11g device, and an IEEE 802.11b device.

4. The method of claim 3, wherein the LRE device is an IEEE 802.11af Mode II device configured to enable a plurality of IEEE 802.11af Mode I devices to connect to the LRE device via one or more channels of an IEEE 802.11af communication network, and wherein the at least one SLR-compatible device is an IEEE 802.11af device.

5. The method of claim 4, wherein the LRE device is configured to operate as a Wi-Fi access point for the plurality of 802.11af Mode I devices.

6. The method of claim 4, wherein the LRE device is configured to enable the plurality of IEEE 802.11af Mode I devices and wherein the LRE device comprises a global positioning system (GPS) receiver.

7. The method of claim 3, wherein the legacy portion of the preamble is decodable by the at least one legacy device and wherein the SLR portion of the preamble is not decodable by the at least one legacy device.

8. The method of claim 3, wherein the legacy portion of the preamble and the SLR portion of the preamble are decodable by the at least one SLR-compatible device.

9. The method of claim 8, wherein the at least one SLR-compatible device is configured to operate at a maximum channel bandwidth of 6 MHz and a data rate of 62.5 Kb/s.

10. The method of claim 3, wherein the packet is transmitted via at least one wireless channel of a plurality of wireless channels and wherein the plurality of wireless channels are based on an IEEE 802.11af communication network.

11. The method of claim 10, wherein the legacy portion of the preamble includes a length field to prevent the at least one legacy device from communicating via the at least one wireless channel for a particular time period.

12. The method of claim 11, wherein the particular time period is based at least in part on a length of the SLR portion of the preamble.

13. The method of claim 1, wherein the legacy portion of the preamble is based on an IEEE 802.11 preamble.

14. The method of claim 13, wherein the at least one bit is in a most significant bit (MSB) position of a service field of the IEEE 802.11 preamble.

15. The method of claim 1, further comprising generating the SLR portion of the preamble by performing bit-level repetition by four on each of a plurality of fields of an IEEE 802.11 preamble.

16. The method of claim 1, wherein the LRE device is configured to communicate with devices in a plurality of networks.

17. A method comprising:
receiving a packet including a preamble at a super long range (SLR)-compatible device; and
decoding a legacy portion of the preamble to determine whether the legacy portion of the preamble includes at least one bit indicating a presence of an SLR portion in the preamble.

18. The method of claim 17, further comprising:
in response to determining that the legacy portion of the preamble includes the at least one bit indicating the presence of the SLR portion in the preamble, initiating decoding of the SLR portion of the preamble.

19. The method of claim 17, wherein the legacy portion of the preamble precedes the SLR portion of the preamble.

20. The method of claim 17, wherein the legacy portion of the preamble is based on an Institute of Electrical and Electronic Engineers (IEEE) 802.11 preamble.

21. The method of claim 20, wherein the at least one bit is in a most significant bit (MSB) position of a service field of the IEEE 802.11 preamble.

22. The method of claim 17, wherein the packet is received via a wireless channel and wherein the wireless channel is based on an Institute of Electrical and Electronics Engineers (IEEE) 802.11af communication network.

23. The method of claim 17, wherein the SLR portion of the preamble includes bit-level repetition by four of each of a plurality of fields of an Institute of Electrical and Electronics Engineers (IEEE) 802.11 preamble.

24. The method of claim 17, further comprising receiving enablement information at the at least one SLR-compatible device, wherein the at least one SLR-compatible device does not include a global positioning system (GPS) receiver.

25. The method of claim 17, further comprising:
receiving the packet including the preamble at a legacy device; and
refraining from communicating via a network medium for a particular length of time specified by a length field of the legacy portion, wherein the legacy device includes at least one of an Institute of Electrical and Electronics Engineers (IEEE) 802.11a device, an IEEE 802.11b device, an IEEE 802.11g device, and an IEEE 802.11b device.

26. A method comprising:
transmitting from a low rate enabler (LRE) device to a legacy device, a clear-to-send (CTS)-to-self message to prevent the legacy device from communicating via a network medium for a duration of time specified by a duration field of the CTS-to-self message; and
during the duration of time:
transmitting a packet including a preamble having a super long range (SLR) portion to an SLR-compatible device; and
receiving an acknowledgement (ACK) packet from the SLR-compatible device.

27. The method of claim 26, further comprising calculating the duration of time based at least in part on a length of the SLR portion of the preamble.

28. The method of claim 26, wherein the CTS-to-self message and the packet are transmitted via at least one wireless channel of a plurality of wireless channels.

29. The method of claim 26, further comprising generating the SLR portion of the preamble by performing bit-level repetition by four on each of a plurality of fields of an Institute of Electrical and Electronics Engineers (IEEE) 802.11 preamble.

30. The method of claim 27, wherein the legacy device includes at least one of an Institute of Electrical and Electronics Engineers (IEEE) 802.11a device, an IEEE 802.11b device, an IEEE 802.11g, or an IEEE 802.11b device, and a non-SLR-compatible device.

31. An apparatus comprising:
a processor; and
a memory storing instructions executable by the processor to:
generate a packet including a preamble having a legacy portion and a super long range (SLR) portion, wherein the legacy portion includes at least one bit to indicate a presence of the SLR portion to at least one SLR-compatible device; and
initiate transmission of the packet to at least one device.

32. The apparatus of claim 31, wherein the processor is integrated into a low rate enabler (LRE) device.

33. The apparatus of claim 31, wherein the packet is transmitted via at least one wireless channel of a plurality of wireless channels and wherein the plurality of wireless channels are based on an Institute of Electrical and Electronic Engineers (IEEE) 802.11af communication network.

34. The apparatus of claim 31, wherein the legacy portion of the preamble includes a length field to prevent at least one legacy device from communicating via the at least one wireless channel for a particular time period and wherein the particular time period is based at least in part on a length of the SLR portion of the preamble.

35. The method of claim 31, wherein the legacy portion of the preamble is based on an Institute of Electrical and Electronic Engineers (IEEE) 802.11 preamble and wherein the at least one bit is in a most significant bit (MSB) position of a service field of the IEEE 802.11 preamble.

36. The method of claim 31, wherein the instructions are further executable by the processor to generate the SLR portion of the preamble by performing bit-level repetition by four on each of a plurality of fields of an Institute of Electrical and Electronic Engineers (IEEE) IEEE 802.11 preamble.

37. An apparatus comprising:
a processor; and
a memory storing instructions executable by the processor to:
detect receipt of a packet including a preamble; and
decode a legacy portion of the preamble to determine whether the legacy portion of the preamble includes at least one bit indicating a presence of an SLR portion of the preamble.

38. The apparatus of claim 37, wherein the processor is integrated into a super long range (SLR)-compatible device and wherein the SLR-compatible device includes a mobile device, a camera, a multimedia player, an entertainment unit, a navigation device, a personal digital assistant (PDA), a portable computer, or any combination thereof.

39. The apparatus of claim 37, wherein the instructions are further executable by the processor to:
in response to determining that the legacy portion of the preamble includes the at least one bit indicating the presence of the SLR portion in the preamble, decode the SLR portion of the preamble.

40. The apparatus of claim 37, wherein the instructions are further executable by the processor to receive geo-location information at the SLR-compatible device, wherein the SLR-compatible device does not include a global positioning system (GPS) receiver.

41. An apparatus comprising:
a processor; and
a memory storing instructions executable by the processor to:
initiate transmission of a clear-to-send (CTS)-to-self message to a legacy device to prevent the legacy device from communicating via a network medium for a duration of time specified by a duration field of the CTS-to-self message; and
during the duration of time:
initiate transmission of a packet including a preamble having a super long range (SLR) portion to an SLR-compatible device; and
detect receipt of an acknowledgement (ACK) packet from the SLR-compatible device.

42. The apparatus of claim 41, wherein the instructions are further executable by the processor to calculate the duration of time based at least in part on a length of the SLR portion of the preamble.

43. The apparatus of claim 42, wherein the wherein the CTS-to-self message and the packet are transmitted via at least one wireless channel of a plurality of wireless channels.

44. The apparatus of claim 41, wherein the processor is integrated into a low rate enabler (LRE) device and wherein the LRE device is an Institute of Electrical and Electronic Engineers (IEEE) 802.11af Mode II device.

45. A non-transitory computer-readable medium storing instructions that, when executed by a processor, cause the processor to:
generate, at a low rate enabler (LRE) device, a packet including a preamble having a legacy portion and a super long range (SLR) portion, wherein the legacy portion includes at least one bit to indicate a presence of the SLR portion to at least one SLR-compatible device; and
initiate transmission of the packet to at least one device.

46. The non-transitory computer-readable medium of claim 45, wherein the legacy portion of the preamble includes a length field to prevent at least one legacy device from communicating via the at least one wireless channel for a particular time period and wherein the particular time period is based at least in part on a length of the SLR portion of the preamble.

47. A non-transitory computer-readable medium storing instruction that, when executed by a processor, cause the processor to:
detect receipt of a packet including a preamble at a super long range (SLR)-compatible device; and
decode a legacy portion of the preamble to determine whether the legacy portion of the preamble includes at least one bit indicating a presence of an SLR portion of the preamble.

48. The non-transitory computer-readable medium of claim 47, further comprising instructions that, when executed by the processor, cause the processor to:
in response to determining that the legacy portion of the preamble includes the at least one bit indicating the presence of the SLR portion in the preamble, decode the SLR portion of the preamble.

49. A non-transitory computer-readable medium storing instructions that, when executed by a processor, cause the processor to:
initiate transmission from a low rate enabler (LRE) device to a legacy device, a clear-to-send (CTS)-to-self message to prevent the legacy device from communicating via a network medium for a duration of time specified by a duration field of the CTS-to-self message; and
during the duration of time:
initiate transmission of a packet including a preamble having a super long range (SLR) portion to an SLR-compatible device; and
detect receipt of an acknowledgement (ACK) packet from the SLR-compatible device.

50. The non-transitory computer-readable medium of claim 49, wherein the instructions are further executable by the processor to calculate the duration of time based at least in part on a length of the SLR portion of the preamble.

51. An apparatus comprising:
means for generating, at a low rate enabler (LRE) device, a packet including a preamble having a legacy portion and a super long range (SLR) portion, wherein the legacy portion includes at least one bit to indicate a presence of the SLR portion to at least one SLR-compatible device; and
means for transmitting the packet to at least one device.

52. The apparatus of claim 51, wherein the legacy portion of the preamble includes a length field to prevent at least one legacy device from communicating via the at least one wireless channel for a particular time period and wherein the particular time period is based at least in part on a length of the SLR portion of the preamble.

53. An apparatus comprising:
means for receiving a packet including a preamble at a super long range (SLR)-compatible device; and
means for decoding a legacy portion of the preamble to determine whether the legacy portion of the preamble includes at least one bit indicating a presence of an SLR portion in the preamble.

54. The apparatus of claim 53, further comprising means for decoding the SLR portion of the preamble in response to determining that the legacy portions of the preamble includes at least one bit indicating the presence of the SLR portion in the preamble.

55. An apparatus comprising:
means for transmitting from a low rate enabler (LRE) device to a legacy device, a clear-to-send (CTS)-to-self message to prevent the legacy device from communicating via a network medium for a duration of time specified by a duration field of the CTS-to-self message; and
means for transmitting, during the duration of time, a packet including a preamble having a super long range (SLR) portion to an SLR-compatible device; and
means receiving an acknowledgement (ACK) packet from the SLR-compatible device.
